(19) United States
(12) Patent Application Publication
(10) Pub. No.: US 2011/0273756 A1
(43) Pub. Date: Nov. 10, 2011

(54) DYNAMICALLY RECONFIGURABLE HOLOGRAMS WITH CHALCOGENIDE INTERMEDIATE LAYERS

(76) Inventors: Shih-Yuan Wang, Palo Alto, CA (US); Lars Helge Thylen, Huddinge, CA (US); Alexandre M. Bratkovski, Mountain View, CA (US); Jingjing Li, Palo Alto, CA (US); Wei Wu, Palo Alto, CA (US)

(21) Appl. No.: 13/142,482

(22) PCT Filed: Dec. 29, 2008
(86) PCT No.: PCT/US08/14084

§ 371 Date: Jun. 28, 2011

(51) Int. Cl. G03H 1/22

(52) U.S. Cl. 359/32; 977/762

(57) ABSTRACT

Various embodiments of the present invention relate to dynamically reconfigurable hologram comprising a phase-modulation layer and an intensity-control layer. The phase modulation layer comprises an electronically programmable erasable negative index material crossbar. The crossbar includes a first layer of approximately parallel nanowires (502) and a second layer of approximately parallel nanowires (504) that overlay the nanowires in the first layer. The nanowires in the first and second layers have substantially regularly spaced fingers. The crossbar also includes resonant elements (812) comprising a chalcogenide-based layer (1000) sandwiched between the nanowire in the first layer and the nanowire in the second layer.

### TECHNICAL FIELD

Embodiments of the present invention relate to holograms, and, in particular, to dynamically reconfigurable metamaterial-based holograms for generating three-dimensional images.

### BACKGROUND

Photographs compress images of three-dimensional objects into flat, two-dimensional images displayed by a piece of paper, and television and motion pictures also compress images of moving three-dimensional objects into flat, moving, two-dimensional images displayed on a screen. Photographs, television, and motion pictures are examples of media that display three-dimensional objects as simply intensity mappings. In other words, when an image of a scene is ordinarily reproduced in a photograph or motion picture, a viewer does not see an accurate reproduction of the light scattered from the object, but instead a viewer sees a point-by-point record of just the square of the electromagnetic radiation amplitude (i.e., the intensity) reflected from the object. For example, the light reflected off a photograph carries with it information about the intensity of the object displayed by the photograph but nothing about the electromagnetic wavefronts that were once scattered from the object during the taking of the photograph. As a result, a viewer only perceives a two-dimensional image of the object. However, when the electromagnetic wavefronts scattered from an object can be reconstructed for a viewer, the viewer sees wavefronts that are indistinguishable from the wavefronts scattered from the original object. Thus, the viewer is able to see a reformed three-dimensional image of the object, as if the object was actually before the viewer.

Holography is a method of recording and showing a still three-dimensional image of an object using a hologram and monochromatic light from a laser. A conventional hologram is a still record of intensity and wavefronts scattered from an object with respect to an incident reference light that contains point-by-point information for reproducing a three-dimensional holographic image of the object, but is not an image of the object. The hologram is used to reconstruct a three-dimensional holographic image of the object in approximately the same position that the object was in when it was recorded. The holographic image changes as the position and orientation of the viewer changes. Thus the holographic image of an object appears three dimensional to the viewer.

However, a hologram can only be used to produce a single still three-dimensional image of an object. The systems used to generate holograms and holographic images are bulky, and the time and number of steps performed to produce a single hologram make current holographic methods and systems impractical for producing three-dimensional motion pictures of objects. Thus, it is desirable to have holographic methods and compact holographic systems that enable the production of full three-dimensional motion pictures.

### BRIEF DESCRIPTION OF THE DRAWINGS

FIGS. 1A-1B show wave and Poynting vector directions for electromagnetic waves propagating in an ordinary right-handed medium.

FIGS. 2A-2B show wave and Poynting vector directions for electromagnetic waves propagating in a negative index metamaterial.

FIG. 3 shows refraction of rays of light in an ordinary right-handed medium and a negative index metamaterial.

FIG. 4 shows focusing properties of a metamaterial slab for light emanating from a point source.

FIG. 5 shows an isometric view of a negative index material crossbar configured in accordance with embodiments of the present invention.

FIG. 6 shows an exploded isometric view of the negative index material crossbar configured in accordance with embodiments of the present invention.

FIG. 7 shows an isometric view of an enlargement of a four adjacent resonant elements of the negative index material crossbar configured in accordance with embodiments of the present invention.

FIG. 8 shows an isometric view of an enlargement of four adjacent resonant elements of a negative index material crossbar configured in accordance with embodiments of the present invention.

FIG. 9 shows a plot of the refractive index and phase changes for an exemplary negative index material crossbar configured and operated in accordance with embodiments of the present invention.

FIG. 10 shows a resonant element that undergoes a phase change in accordance with embodiments of the present invention.

FIG. 11 shows switching the intermediate layer of a resonant element from an amorphous phase to a crystalline phase and back by applying current pulses in accordance with embodiments of the present invention.

FIG. 12 shows switching the intermediate layer of a resonant element from an amorphous phase to a crystalline phase and back by applying electromagnetic radiation pulses of appropriate wavelengths and duration in accordance with embodiments of the present invention.

FIG. 13 shows an exploded isometric view of an electronically addressable dynamic hologram configured in accordance with embodiments of the present invention.

FIG. 14 shows an exploded isometric view of a phase-control layer configured in accordance with embodiments of the present invention.

FIG. 15 shows a number of highlighted phase-modulation pixels associated with different refractive indices in accordance with embodiments of the present invention.

FIG. 16 shows an isometric view and an enlargement of a region of a phase-control layer in accordance with embodiments of the present invention.

FIG. 17 shows an isometric view and enlargement of a region of the phase-control layer shown in FIG. 15 configured and operated using currents in accordance with embodiments of the present invention.

FIG. 18 shows an isometric view and enlargement of a region of the phase-control layer shown in FIG. 15 configured and operated using electromagnetic radiation in accordance with embodiments of the present invention.

FIG. 19 shows a side view of rays of light passing through three pixels of a phase-control layer operated in accordance with embodiments of the present invention.

FIG. 20 shows a side view of quasimonochromatic light wavefront passing through a phase-control layer in accordance with embodiments of the present invention.

FIG. 21 shows intensity levels associated with rays passing through pixels of a phase-modulation layer and an intensity-control layer in accordance with embodiments of the present invention.

FIG. 22 shows a system for generating three-dimensional images in accordance with embodiments of the present invention.

FIG. 23A shows a schematic representation of a viewing angle over which an observer can view a three-dimensional virtual image with a hologram configured in accordance with embodiments of the present invention.

FIG. 23B shows a schematic representation of a hologram displaying three different three-dimensional images in accordance with embodiments of the present invention.

### DETAILED DESCRIPTION

Various embodiments of the present invention relate to negative refractive index-based systems that can be used as holograms and can be electronically controlled and dynamically reconfigured to generate one or more three-dimensional motion pictures. The systems include a phase-control layer and an intensity-control layer. The phase-control layer is composed of a chalcogenide glass-based negative index material crossbar array that enables individual pixels to be electrically addressed and allows for pixelized phase modulation of refracted or reflected electromagnetic radiation. As a result, the phase-control and intensity-control layers produce phase and intensity changes in refracted or reflected light that can be dynamically controlled pixel-by-pixel in order to dynamically display one or more three-dimensional images.

### Negative Index Materials

Negative index materials (“NIMs”), also called metamaterials are materials with optical properties resulting from the structure of the material rather than from chemical composition of the material. Natural materials have positive permeability, μ, and may have positive or negative dielectric permittivity ∈, depending on the type of conductivity of the material and frequency ranges. In contrast, NIMs with simultaneously negative ∈ and μ results in optical properties that are different from those of ordinary composite materials. The optical properties of NIMs can be appreciated by comparing and contrasting the optical properties of NIMs with the optical properties of ordinary composite materials, as described in Electrodynamics of Metamaterials, by A. K. Sarychev and V. M. Shalaev (World Scientific, New York, 2007). For example, consider Maxwell's first-order differential equations for an electromagnetic wave propagating in an ordinary composite material with a time harmonic field as follows, presuming temporal behavior exp (jωt):

∇×\vec{E}=−jωμ\vec{H}

∇×\vec{H}=jω∈\vec{E}

where \vec{E} is the electric field component, \vec{H} is the magnetic field component, j=\sqrt{−1}, and ω is the angular frequency. The solutions of these equations are the plane-wave fields:

\vec{E}=\vec{E}₀exp(−j\vec{k}₀□\vec{r})

\vec{H}=\vec{H}₀exp(−j\vec{k}₀□\vec{r})

Substituting the plane-wave equations into Maxwell's first order differential equations gives the relations:

\vec{k}₀×\vec{E}=ωμ\vec{H}

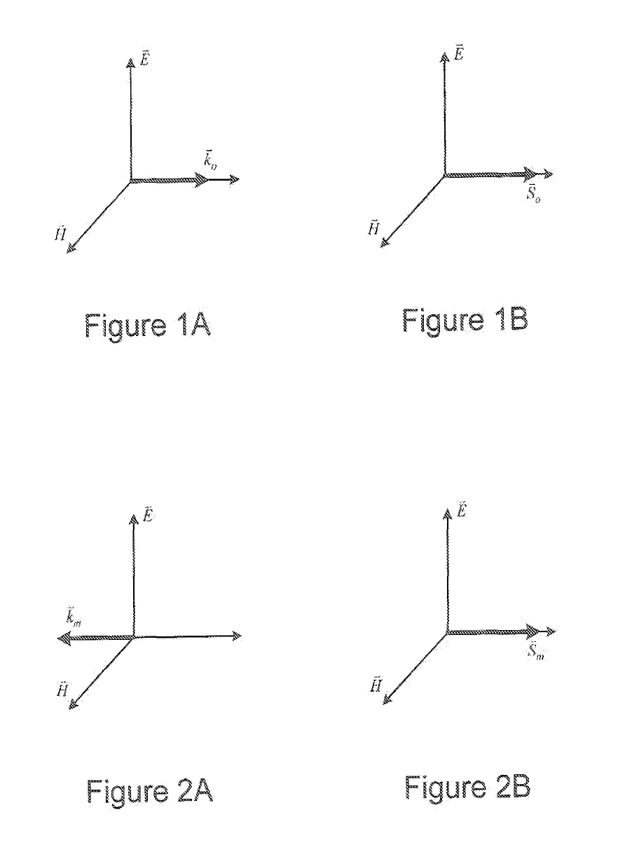

\vec{k}₀×\vec{H}=−ω∈\vec{E}

where \vec{k}₀ is a wavevector indicating the direction an electromagnetic wave propagates within a composite material. FIG. 1A shows the spatial relationship and relative orientation of the vectors \vec{E}, \vec{H}, and \vec{k}₀ and reveals that for an ordinary composite material with positive ∈ and μ, the vectors \vec{E}, \vec{H}, and \vec{k}₀ form an orthogonal, right-handed system of vectors. In addition, the direction of the time-averaged energy flux of the electromagnetic wave is given by the real component of the Poynting vector:

$${\vec{S}}_{o} = \frac{1}{2} Re ( \vec{E} \times {\vec{H}}^{*} )$$

which, as shown in FIG. 1B, reveals that the vectors \vec{E}, \vec{H}, and \vec{S}₀ also form an orthogonal, right-handed vector system. In other words, FIGS. 1A and 1B, show that for an electromagnetic wave propagating through a ordinary composite material, the propagation direction identified by the wavevector \vec{k}₀ and the direction of the energy carried by the electromagnetic wave identified by the Poynting vector \vec{S}₀ are the same.

On the other hand, consider NIMs, where ∈<0 and μ<0. Maxwell's first order differential equations give the relations:

\vec{k}ₘ×\vec{E}=−ω|μ|\vec{H}

\vec{k}ₘ×\vec{H}=ω|∈|\vec{E}

where \vec{k}ₘ is a wavevector indicating the direction the phase of the electromagnetic wave propagates in a NIM. As shown in FIG. 2A, and in contrast to the composite materials shown in FIG. 1A, for NIMs, the vectors \vec{E}, \vec{H}, and \vec{k}ₘ form an orthogonal, left-handed system of vectors. In other words, comparing the directions of the wavefronts represented by the wavevectors \vec{k}_{c} and \vec{k}ₘ shown in FIGS. 1A and 2A, respectively, reveals that electromagnetic waves propagate backwards in NIMs for the same orientation of the vectors \vec{E} and \vec{H}. Thus, NIMs are also referred to as “left-handed media” or “backward media.” However, as shown in FIG. 2B, the Poynting vector \vec{S}ₘ in a metamaterial is unaffected by the change of sign of ∈ and μ, and the vectors \vec{E}, \vec{H}, and \vec{S}ₘ still form an orthogonal, right-handed system of vectors in a left-handed medium. Therefore, in NIMs, energy and wavefronts travel in opposite directions.

Now consider the refraction of an incident ray at the interface between ordinary and left-handed media. Based on the properties of electromagnetic waves travelling in NIMs described above, it follows that, unlike refraction observed in ordinary media, the angles-of-incidence and refraction have opposite signs. Snell's law in NIMs becomes:

$$\frac{sin {θ}_{1}}{sin {θ}_{2}} = \frac{- \vert {k}_{2} \vert}{\vert {k}_{1} \vert} ≡ \frac{{n}_{2}}{{n}_{1}} < 0 ,$$

where the subscripts 1 and 2 identify ordinary and left-handed media, respectively. Assuming n₁>0, from Snell's law is follows that n₂<0. That is, the sign of the square root in the definition of the refractive index is chosen to be negative:

n₂=−\sqrt{∈μ}<0

Hence the term “negative index material” is used to refer to materials having both negative ∈ and μ.

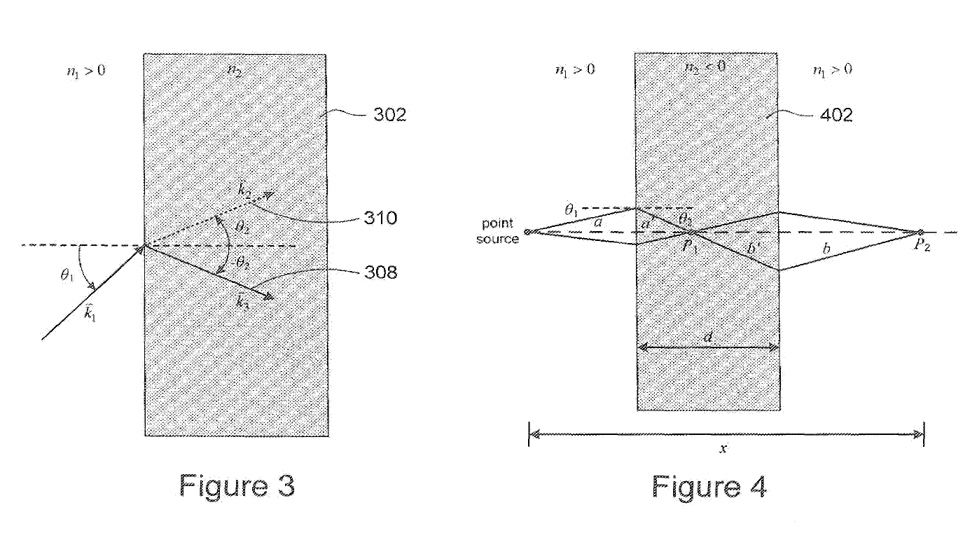

FIG. 3 shows refraction of rays of light in an ordinary right-handed medium and a negative index metamaterial. Dashed line 304 represents a surface normal extending perpendicular to the surface of the medium 302. As shown in FIG. 3, angle θ₁ and wavevector 306 represent the angle-of-incidence and direction of a ray of light propagating through an ordinary medium with index of refraction n₁>0 and is incident on the medium 302. Angle −θ₂ and wavevector \vec{k}₃ 308 represent the angle-of-refraction and direction of a refracted ray of light propagating within the medium 302 with refractive index n₂<0, while angle θ₂ and wavevector \vec{k}₂ 310 represent the angle-of-refraction and direction of a refracted ray of light propagating within the medium 302 with refractive index n₂>0, where |n₂|>n₁. Thus, for the medium 302 with a refractive index of n₂<0, the incident ray 306 and the refracted ray 308 lie on the same side of the surface normal 304, and for the medium 302 with a refractive index of n₂>0, the incident ray 306 and the refracted ray 310 lie on opposite sides of the surface normal 304.

Tracing the paths of optical rays through conventional concave and convex lens made of left-handed media reveals that concave lenses become convergent and convex lens become divergent, thus reversing the behavior of lenses comprising ordinary media. FIG. 4 shows focusing properties of a slab 402 composed of a NIM for light emanating from a point source. For incident rays paraxial to an optical axis 404, Snell's law gives:

$$\vert n \vert = \frac{\vert {n}_{2} \vert}{{n}_{1}} = \frac{\vert sin {θ}_{1} \vert}{\vert sin {θ}_{2} \vert} • \frac{\vert tan {θ}_{1} \vert}{\vert tan {θ}_{2} \vert} = \frac{{a}^{′}}{a} = \frac{{b}^{′}}{b}$$

where n is the refractive index n₂ of the slab 402 relative to refractive index of the surrounding medium n₁. As shown in FIG. 4, rays emanating from the point source are focused at two points P₁ and P₂. Point P₁ lies inside the slab 402 and point P₂ lies on the side of the slab 402 opposite the point source. The distance from the point source to the second focusing point P₂ is given by:

$$x = a + {a}^{′} + {b}^{′} + b = d + \frac{d}{\vert n \vert}$$

where d is the width of the slab. When n equals −1, the focusing effect is not restricted to paraxial rays, because in this case |θ₁| equals |θ₂| for any angle-of-incidence. In fact, when n equals −1, all rays emanating from the point source are focused at two points, the latter point P₂ being at a distance 2d from the point source. Thus, unlike slabs comprising ordinary composite materials, slabs composed of NIMs can be configured to focus light.

### Negative Index Material Crossbars

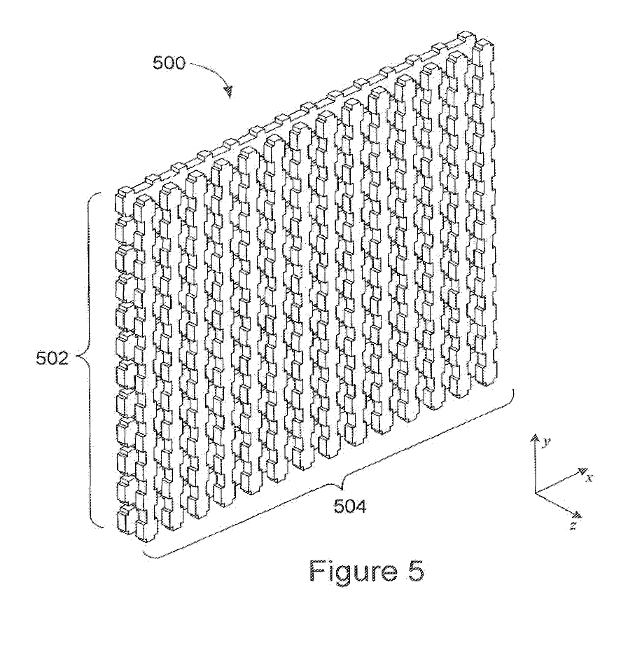

FIG. 5 shows an isometric view of a NIM crossbar 500 configured in accordance with embodiments of the present invention. The NIM crossbar 500 comprises a first layer of approximately parallel nanowires 502 that are overlain by a second layer of approximately parallel nanowires 504. The nanowires of the first layer 502 run substantially parallel to the x-axis and are approximately perpendicular, in orientation, to the nanowires of the second layer 504, which run substantially parallel to the y-axis, although the orientation angle between the nanowires of the layers 502 and 504 may vary. The two layers of nanowires form a lattice, or crossbar, with each nanowire of the second layer 504 overlying all of the nanowires of the first layer 502 and coming into close contact with each nanowire of the first layer 502 at nanowire intersections called “resonant elements” that represent the closest contact between two nanowires.

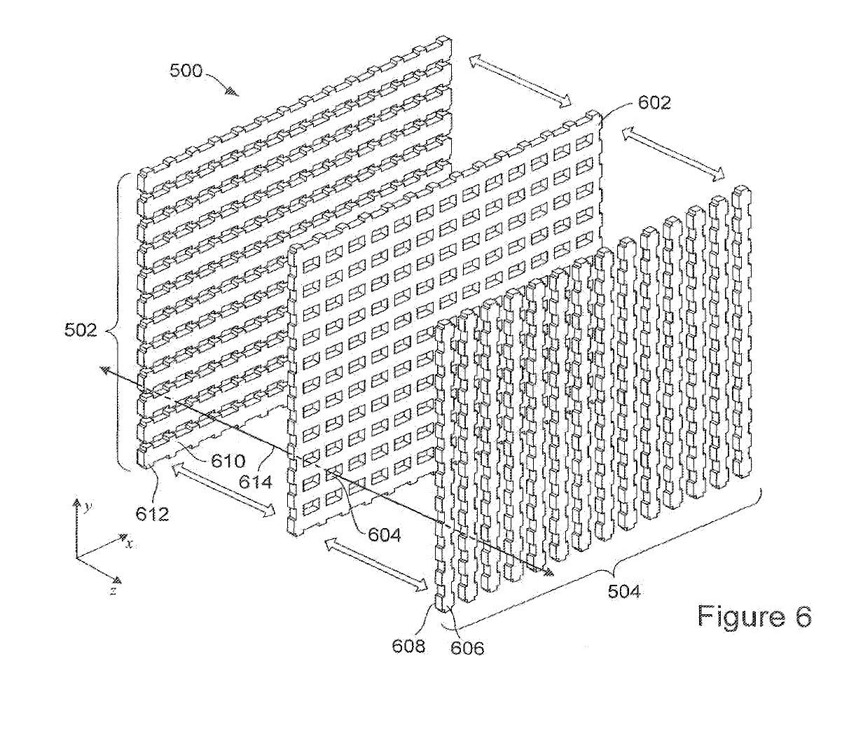

FIG. 6 shows an exploded isometric view of the NIM crossbar 500 configured in accordance with embodiments of the present invention. FIG. 6 reveals an intermediate layer 602 sandwiched between the first layer of nanowires 502 and the second layer of nanowires 504. The intermediate layer 602 is a continuous layer including an array of regularly spaced holes, such as hole 604. In certain embodiments, as shown in FIG. 6, the holes can be rectangular, and in other embodiments, the holes can be square. The nanowires in the first layer 502 have relatively larger cross-sectional dimensions than the nanowires comprising the second layer 504. FIG. 6 also reveals that the nanowires in both the first and second layers 502 and 504 are configured with substantially regularly spaced protuberances called “fingers” that are separated by notches. For example, nanowire 606 includes a finger 608 and nanowire 610 includes a finger 612. The fingers of nanowires of one layer are approximately parallel to the direction of the nanowires in the other layer. The fingers of adjacent nanowires are also substantially aligned within the first and second layers 502 and 504, and the holes in the intermediate layer 602 are substantially aligned with the notches between fingers in the first and second layers 502 and 504. For example, line 614 passes through notches in the first layer 502, passes through the hole 604 in the intermediate layer 602, and passes through notches in the second layer 504.

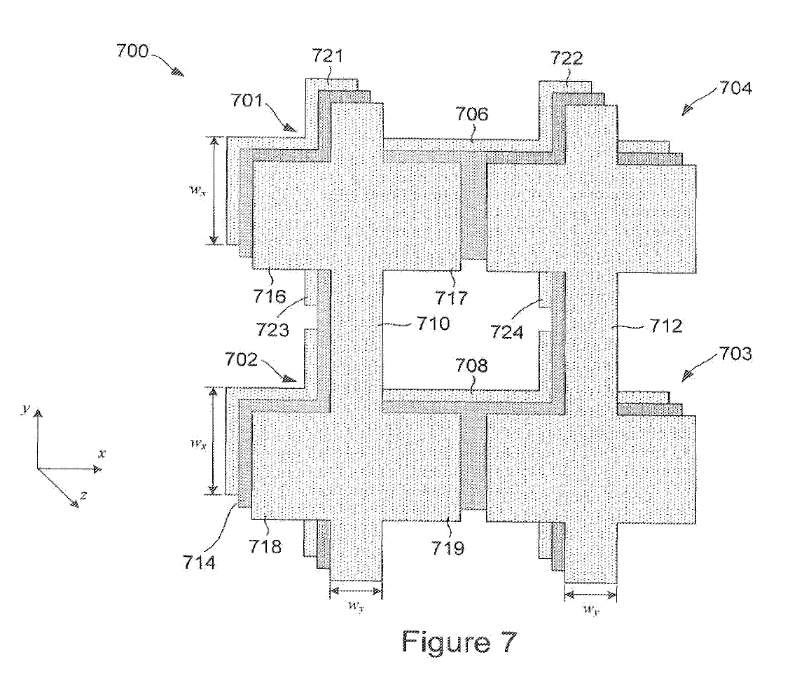

FIG. 7 shows an isometric view of an enlargement 700 of a four adjacent resonant elements 701-704 of the NIM crossbar 500 configured in accordance with embodiments of the present invention. The resonant elements 701-704 are formed where nanowires 710 and 712 extending in the x-direction overlay portions of nanowires 706 and 708 extending in the y-direction. The nanowires 706 and 708 are separated from the nanowires 710 and 712 by an intermediate layer 714. The width wₓ of the nanowires 706 and 708 in the first layer 502 is larger than the width w_{y} of the nanowires 710 and 712 in the second layer 504. The nanowires 710 and 712 include fingers protruding in the x-direction, such as fingers 716-719 of nanowire 710, and nanowires 706 and 708 include fingers protruding in the y-direction, such as fingers 721-724 of nanowire 708. The fingers of adjacent nanowires lying in the same layer are separated by gaps. As shown in FIG. 7, each of the resonant elements 701-704 includes a portion of the intermediate layer sandwiched between two fingers of a nanowire in the first layer 502 and two fingers of a nanowire in the second layer 504. For example, resonant element 701 includes fingers 716 and 717 of nanowire 710 and fingers 721 and 723 of nanowire 706 and a portion of the intermediate layer 714 sandwiched there between.

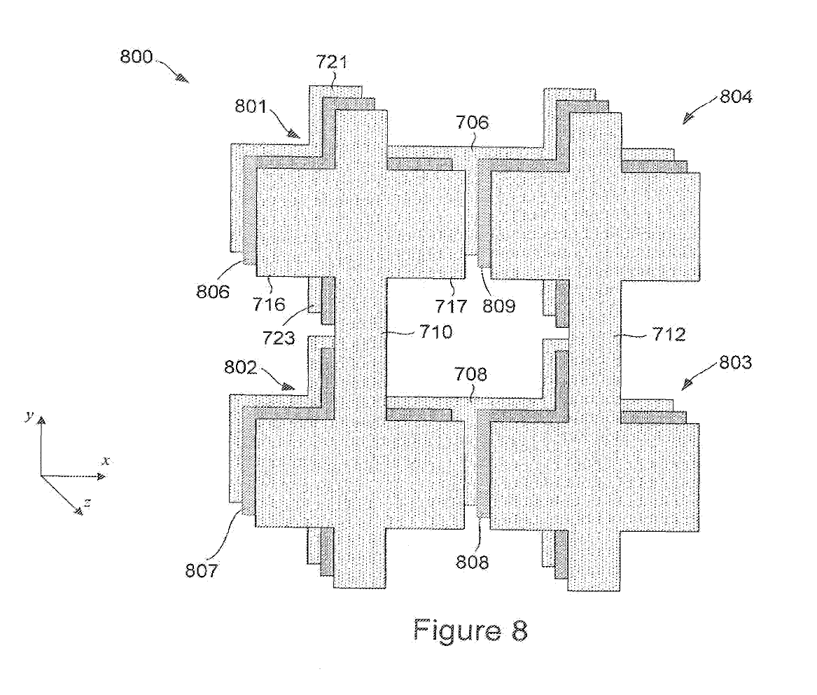

In other embodiments, the intermediate layer 602 may be composed of discrete portions of a material lying within each resonant element. FIG. 8 shows an isometric view of an enlargement 800 of four adjacent resonant elements 801-804 of a NIM crossbar configured in accordance with embodiments of the present invention. The resonant elements 801-804 include intermediate plus-shaped layers 806-809, respectively, sandwiched between the nanowires 710 and 712 overlaying nanowires 706 and 708. As shown in FIG. 8, adjacent plus-shaped layers 806-809 are separated by gaps, and each plus-shaped layer fills the space between the nanowire of one layer and the fingers of a nanowire in another layer. For example, plus-shaped layer 806 is configured to fill the space between fingers 721 and 723 and nanowire 710 and fill the space between fingers 716 and 717 and nanowire 706.

Embodiments of the present invention are not limited to the rectangular configurations for the fingers of the nanowires, as shown in FIGS. 5-8. In other embodiments, the fingers can be elliptical, circular, square, irregularly shaped, or have more complex shapes, dictated by design of supporting a magneto-plasmon resonance and related NIM behavior over a particular frequency range. Although the fingers shown in FIGS. 5-8 have clearly defined edges, in practice, the fingers may have rounded edges.

Although individual nanowires shown in FIGS. 5-8 have rectangular cross sections, nanowires can also have square, circular, elliptical, or more complex cross sections. The nanowires may be configured to have many different widths or diameters and aspect ratios or eccentricities ranging from approximately ⅕ to approximately 1/20 of the wavelength of incident light or ranging from approximately 20 nm to approximately 200 nm. The term “nanowire crossbar” may refer to crossbars having one or more layers of sub-microscale wires, microscale wires, or wires with larger cross-sectional dimensions, in addition to nanowires. The nanowires can be composed of silver (“Ag”), gold (“Au”), copper (“Cu”), aluminum (“Al”), platinum (“Pt”), or another suitable electronically conducting metal, or the nanowires can be composed of heavily doped semiconductors depending on the frequency of incident light.

The crossbar layers can be fabricated by mechanical nanoimprinting techniques. Alternatively, nanowires can be chemically synthesized and can be deposited as layers of approximately parallel nanowires in one or more processing steps, including Langmuir-Blodgett processes with subsequent patterning. Other alternative techniques for fabricating nanowires may also be employed. Thus, a two-layer nanowire crossbar comprising first and second layers of nanowires, as shown in FIGS. 5-8, can be manufactured by any of numerous relatively straightforward processes. Many different types of conductive and semi-conductive nanowires can be chemically synthesized from metallic and semiconductor substances, from combinations of these types of substances, and from other types of substances. The individual nanowires of a nanowire crossbar may be connected to microscale address-wire leads or other electronic leads, through a variety of different methods in order to electronically couple the nanowires to electronic devices.

The resonant elements can be configured with dimensions that are smaller than the wavelength λ of light incident on the crossbar 500 enabling the crossbar 500 to be selectively operated as a NIM over particular wavelength ranges. In particular, the size and shape of the fingers can be selected to have an appropriate inductance, resistance, and capacitance response to the wavelengths of incident light on the crossbar. In addition, because each resonant element can be separately addressed by biasing the pair of nanowires crossing at the selected resonant element, the refractive index of the intermediate layer of each resonant element can be adjusted by applying appropriate currents to the nanowires. The size and shape of the fingers and control over the refractive index of the intermediate layer of the resonant elements enables the crossbar 500 to be configured and operated as a NIM over particular wavelength ranges and shift the transmission phase of light transmitted through the crossbar 500.

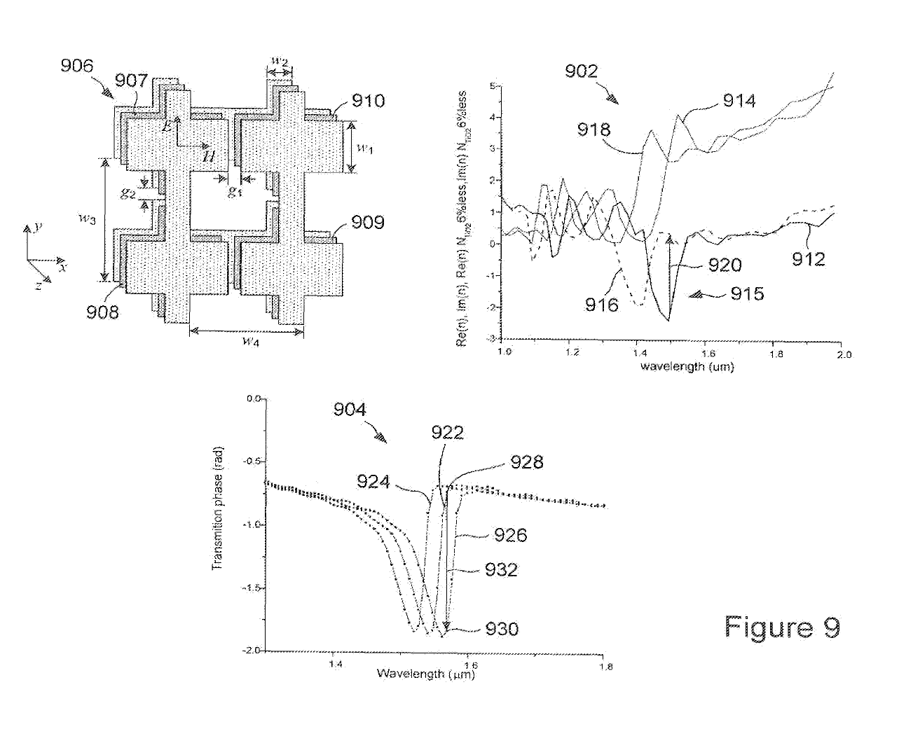

FIG. 9 shows a plot of the refractive index 902 and phase changes 904 for an exemplary NIM crossbar configured and operated in accordance with embodiments of the present invention. Plots 902 and 904 were obtained using the well-known finite-difference time-domain method (“FDTD”) described in Computational Electrodynamics. The Finite-Difference Time-Domain Method, Third Edition, by Allen Taflove and Susan C. Hagness, Artech House (2005). FIG. 9 also includes a crossbar 906 representing four adjacent resonant elements with parameters identifying the dimensions of the nanowires, fingers, and spacing between resonant elements used to obtain the results displayed in plots 902 and 904. The dimensions of the parameters identified in the crossbar 906 are provided in Table I as follows:

TABLE I

| Parameter | Dimension |
|---|---|
| w₁ | 225 nm |
| w₂ | 90 nm |
| w₃ | 450 nm |
| w₄ | 450 nm |
| g₁ | 45 nm |
| g₂ | 45 nm |

The nanowires are composed of Ag, and the plus-shaped intermediate layers 907-910 are composed of TiO₂ with a thickness of 60 nm.

For light polarized in the y-direction and incident on the crossbar 906 in the z-direction, curves 912 and 914 of plot 902 represent the real and imaginary refractive index components, respectively, over a range of wavelengths when no current flows through the resonant elements of the crossbar 906. A portion 915 of the real component 912 indicates that the crossbar 906 exhibits a negative refractive index for incident light with wavelengths ranging from approximately 1.42 μm to approximately 1.55 μm with the largest negative refractive index occurring for incident light with wavelengths of approximately 1.5mm. Curves 916 and 918 of plot 902 represent the real and imaginary refractive index components with a 6% change in the refractive index when appropriate currents flow through the nanowires of the crossbar 906. Curve 916 exhibits a real negative refractive index shift for incident light with wavelengths ranging from approximately 1.32mm to approximately 1.46 μm with the largest negative refractive index occurring for incident light with wavelengths of approximately 1.4 μm. In other words, the refractive index of the resonant elements of the crossbar 906 can be changed so that incident light over particular wavelength ranges encounters a different refractive index. For example, incident light with a wavelength of approximately 1.5 μm encounters the strongest real negative refractive index component when no current flows through the crossbar 906. However, when appropriate currents flow through the nanowires, the refractive index encountered by the incident light is shifted to a positive value as indicated by directional arrow 920.

A change in the refractive index encountered by incident light shifts the transmission phase of light transmitted through the crossbar. Curves 922-924 of plot 904 represent the transmission phase of light over a range of wavelengths passing through the crossbar 906 for three different refractive indices. The transmission phase is the phase acquired by light transmitted through the crossbar 906. For example, point 928 indicates that incident light with a wavelength of approximately 1.58 μm transmitted through the crossbar 906 acquires a transmission phase of approximately −0.7 radians. Curve 922 represents the transmission phase acquired by light over a range of wavelengths transmitted through the crossbar 906 when no current is applied to the crossbar 906. Curve 924 represents the transmission phase acquired by light over a range of wavelengths transmitted through the crossbar 906 when currents applied to the nanowires of the crossbar 906 increase the refractive index of the intermediate layers 907-910 by 3%. And curve 926 represents the transmission phase acquired by light over a range of wavelengths transmitted through the crossbar 906 when currents applied to the nanowires of the crossbar 906 decrease the refractive index of the intermediate layers 907-910 by 3%. The crossbar 906 can be operated to shift the phase acquired by transmitted light. For example, when currents corresponding to the curve 926 are applied to the crossbar 906, the incident light with wavelengths of approximately 1.58 μm acquire a transmission phase of approximately −1.78radians, which is a transmission phase shift of approximately −1.2radians from the point 928 to the point 930, as indicated by directional arrow 932.

### Resonant Elements

The materials selected for the intermediate layer of the resonant elements exhibit an appreciable refractive index change in response to externally applied electric fields or illumination with electromagnetic radiation (“ER”) of appropriate wavelength. The refractive index of the resonant elements can vary according to a phase change in the materials comprising the intermediate layer. These materials can be chalcogenide glasses which are a group of bandgap semiconductor materials containing one or more chalcogens, such as sulfur (“S”), selenium (“Se”), and tellurium (“Te”), in combination with relatively more electropositive elements, such as arsenic (“As”), germanium (“Ge”), phosphorous (“P”), antimony (“Sb”), bismuth (“Bi”), silicon (“Si”), tin (“Sn”), and other electropositive elements. Examples of chalcogenide glasses include that can be used to form the intermediate layer include GeSbTe, GeSb₂Te₄, InSe, SbSe, SbTe, InSbSe, InSbTe, GeSbSe, GeSbSeTe, AgInSbTe, AgInSbSeTe, and AsₓSe₁₋ₓ, AsₓS₁₋₁, and As₄₀S₆₋ₓSeₓ, where x ranges between 0 and 1. This list is not intended to be exhaustive, and other suitable chalcogenide glasses can be used to form the intermediate layer of a resonant element.

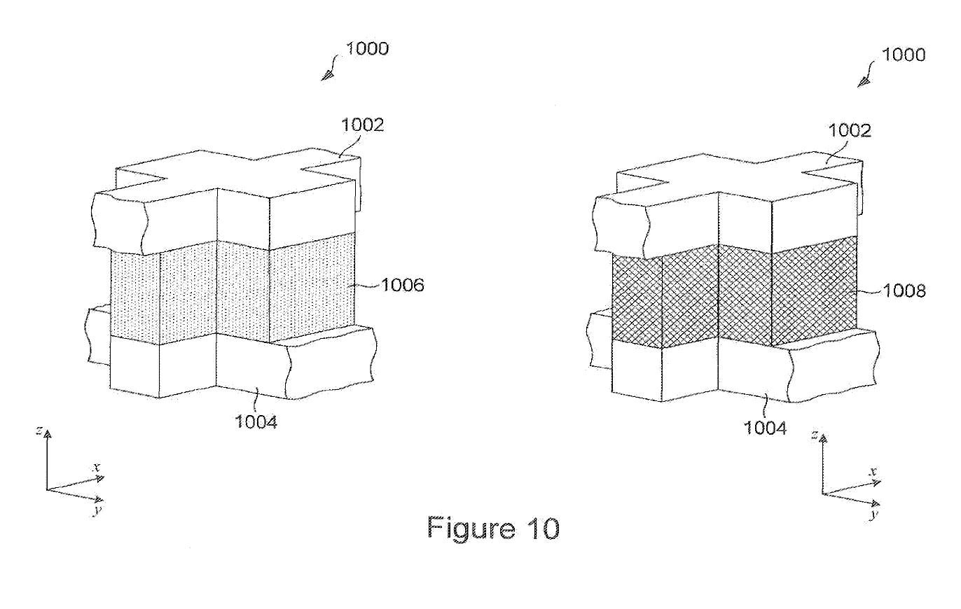

FIG. 10 shows a resonant element 1000 that undergoes a phase change in accordance with embodiments of the present invention. The resonant element 1000 comprises a portion of a first nanowire 1002 in a first layer of nanowires extending in the x-direction overlaying a portion of a second nanowire 1004 in a second layer of nanowires extending the y-direction. The resonant element 1000 includes an intermediate layer 1006 composed of chalcogenide glass sandwiched between the nanowires 1002 and 1004 with a thickness range from about 30 nm to about 80 nm. In FIG. 10A, shaded intermediate layer 1006 represents the chalcogenide glass in an amorphous phase. An amorphous phase is a solid phase in which there is no long-range order of the positions of atoms and molecules comprising the solid. On the other hand, in FIG. 10B, hash-marked intermediate layer 1008 represents the chalcogenide glass in a crystalline phase. In contrast to an amorphous phase, the atoms and molecules in a crystalline phase are arranged in an orderly repeating pattern extending over a long range in all three spatial dimensions. However, the refractive indices of the amorphous and crystalline phases are different. Typically, a solid material in an amorphous phase absorbs and/or scatters more light than a solid composed of the same material in a crystalline phase. In other words, a solid material in an amorphous phase typically has a higher refractive index than a solid composed of the same material in a crystalline phase. For example, a phase change in a chalcogenide glass AsSSe exhibits approximately a 10% change in the refractive index. The intermediate layer is a memristor because the intermediate layer remains in either the amorphous phase or the crystalline phase until a current pulse is applied or until the intermediate layer is illuminated with a pulse of ER.

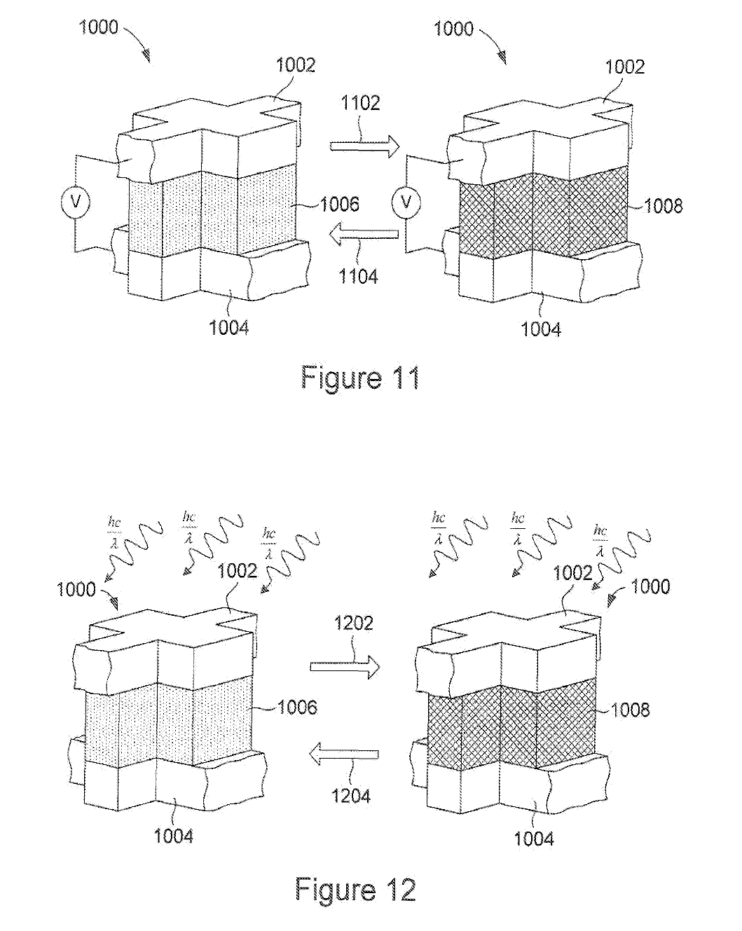

A chalcogenide glass-based intermediate layer can be switched between an amorphous phase and a crystalline phase by applying a current pulse of an appropriate magnitude and duration. While the current pulse flows through the intermediate layer, the resistance of the chalcogenide glass causes the chalcogenide glass to heat up and the atoms and molecules comprising the intermediate layer to reorganize. The initial phase and duration of the current pulse determines which of the two phases, amorphous or crystalline, the chalcogenide glass ends up in. FIG. 11 shows switching the intermediate layer of the resonant element 1000 from the amorphous phase 1006 to the crystalline phase 1008 and back by flowing current pulses through the intermediate layer in accordance with embodiments of the present invention. Consider first the intermediate layer in the amorphous phase 1006. The duration t_{a→c} of the current pulse flowing through the intermediate layer is selected so that atoms and molecules have sufficient time to reorganize into the crystalline phase 1008, as indicated by directional arrow 1102. Now consider the intermediate layer in the crystalline phase 1008. The current pulse in this case has a relatively shorter duration t_{c→a}, where t_{c→a}<t_{a→c}. The intermediate layer heats up and the atoms and molecules become disorganized, but because the duration t_{c→a} is relatively short, the atoms and molecules do not have sufficient time to reorganize back into the crystalline phase 1008. As a result, the atoms and molecules reorganize into the amorphous phase 1002, as indicated by directional arrow 1104. The duration of the current pulses can be on the order of milliseconds. For example, switching the intermediate layer in the amorphous phase 1006 into the crystal phase 1008 may take approximately 20 ms, while switching from the crystalline phase 1008 into the amorphous phase 1006 may take approximately 10 ms.

A chalcogenide glass-based intermediate layer can also be switched between an amorphous phase and a crystalline phase by illuminating the chalcogenide glass with an ER pulse of an appropriate wavelength and duration. Illuminating a chalcogenide glass with electromagnetic radiation of an appropriate wavelength modifies the atomic and molecular structure of the intermediate layer which changes the electronic structure of the intermediate layer and leads to appreciable changes in the optical properties of the chalcogenide glass. FIG. 12 shows switching the intermediate layer of the resonant element 1000 from the amorphous phase 1006 to the crystalline phase 1008 and back by applying ER pulses of appropriate wavelengths and duration in accordance with embodiments of the present invention. Consider first the intermediate layer in the amorphous phase 1006. The resonant element 1000 can be illuminated by ER with a wavelength 2, such as light with a wavelength in the infrared portion of the electromagnetic magnetic spectrum. The wavelength and duration T_{a→c}of the ER pulse enables the atoms and molecules to organize into the crystalline phase 1008, as indicated by directional arrow 1202. Illuminating the intermediate layer in the crystalline phase 1008 with an ER pulse for a relatively shorter duration T_{c→a}, where T_{c→a}<T_{a→c}, modifies the structure of the atoms and molecules into the disordered amorphous phase 1002, as indicated by directional arrow 1204. The duration of the ER pulses can be on the order of milliseconds. For example, switching the intermediate layer in the amorphous phase 1006 into the crystal phase 1008 may take approximately 20 ms, while switching from the crystalline phase 1008 into the amorphous phase 1006 may take approximately 10 ms.

### Dynamically Reconfigurable Holograms

Dynamically reconfigurable holograms can be configured with NIM crossbars and resonant elements described above in the subsections Negative Index Material Crossbars and Resonant Elements.

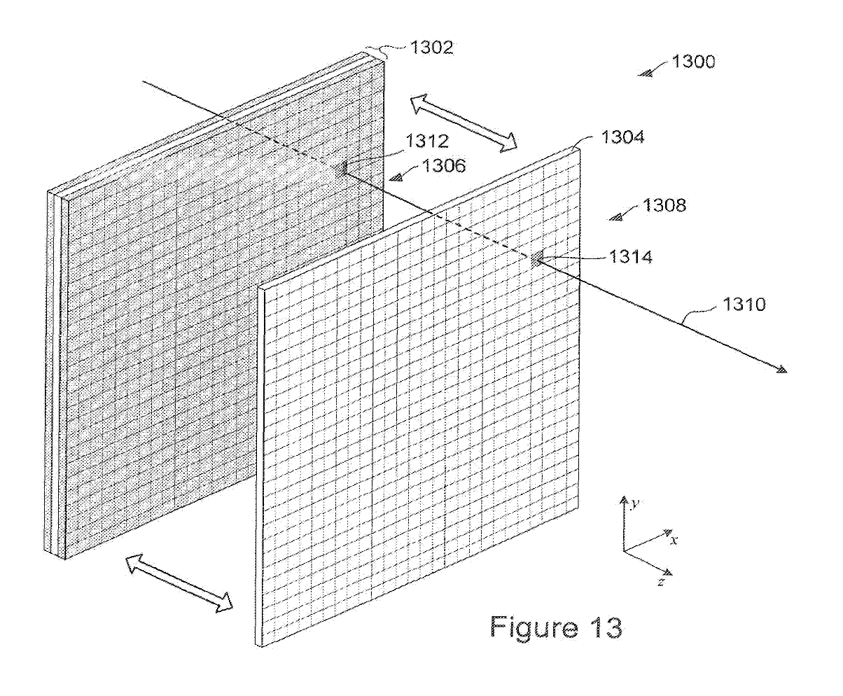

FIG. 13 shows an exploded isometric view of an electronically addressable and dynamically reconfigurable hologram 1300 configured in accordance with embodiments of the present invention. The hologram 1300 includes a phase-control layer 1302 and an intensity-control layer 1304. The surface 1306 of phase-control layer 1302 and the surface 1308 of intensity-control layer 1304 include grid lines that outline two different two-dimensional arrays of squares. Each square represents a pixel, and each pixel of phase-control layer 1302 is substantially aligned with a pixel of intensity-control layer 1304. The pixels in phase-control layer 1302 are referred to as “phase-modulation pixels” and the pixels in intensity-control layer 1304 are referred to as “intensity-control pixels.” For example, as shown in FIG. 13, directional arrow 1310 passes through a highlighted first phase-modulation pixel 1312 located in phase-control layer 1302 and passes through a second highlighted intensity-control pixel 1314 located in intensity-control layer 1304.

The phase-control layer 1302 is a resonant plasmonic metamaterial that can be operated to exhibit negative refraction for particular wavelengths of light. The resonant behavior translates into large phase changes of refracted light. The refractive index of each phase-modulation pixel in phase-control layer 1302 can be independently and electronically controlled, and the transparency of each intensity-control pixel in intensity-control layer 1304 can also be independently and electronically controlled. In other words, the phase-modulation pixels and the intensity-control pixels are “electronically addressable.” For a ray of light passing through any pair of aligned phase-modulation and intensity-control pixels, a transmission phase can be applied to the ray by the phase-modulation pixel in the phase-control layer 1302 followed by a reduction in the intensity produced by the corresponding intensity-control pixel in the intensity-control layer 1304. For example, suppose directional arrow 1310 represents a ray of light originating from a light source (not shown) located behind phase-control layer 1302. As the ray passes through the phase-modulation pixel 1312, a first current flowing through the pixel 1312 induces a change in the refractive index of the pixel 1312. As a result, the ray 1310 acquires a transmission phase as it emerges from the pixel 1312, and it may also exhibit an intensity decrease due to insertion loss. As the ray subsequently passes through intensity-control pixel 1314, a second current flowing through the pixel 1314 changes the transparency of the pixel 1314 and, thus, adjusts the intensity of the ray as it emerges from the intensity-control layer 1304 to render a holographic image by taking into account any optical insertion losses. In other words, the phase-control layer 1302 and the intensity-control layer 1304 can be operated in conjunction to produce both transmission phases and intensity variations in light transmitted through individual pixels of the phase-control layer 1302 and the intensity-control layer 1304. As a result, three-dimensional images can be produced by the collective optical effect of controlling the wavefront and the intensity of light emerging from the hologram 500. Because the effective refractive index and the intensity of each pixel can be separately and electronically controlled, three-dimensional motion pictures can be produced. A more detailed description of the operation of the hologram 1300 is described below.

Embodiments of the present invention are not limited to a one-to-one correspondence between phase-modulation pixels and intensity-control pixels. In other embodiments, the phase-modulation pixels and intensity-control pixels can be arranged and configured so that light is transmitted through one or more phase-modulation pixels and subsequently is transmitted through one or more intensity-control pixels.

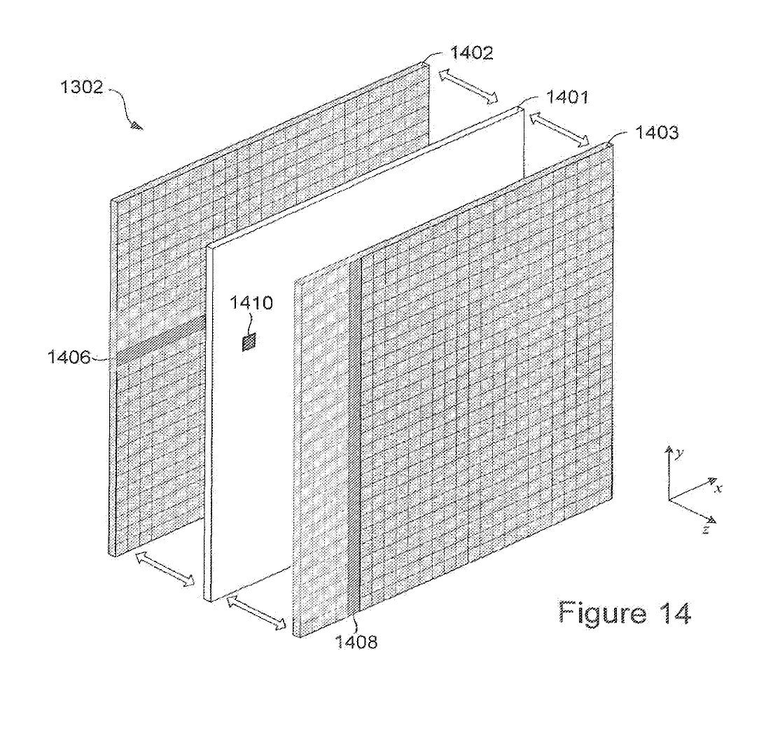

FIG. 14 shows an exploded isometric view of the phase-control layer 1302 configured in accordance with embodiments of the present invention. As shown in FIG. 14, the phase-control layer 1302 comprises an intermediate phase-modulation layer 1401 sandwiched between two outer conductive layers 1402 and 1403. Each phase-modulation pixel can be electronically addressed as follows. The conductive layers 1402 and 1403 are configured so that currents flow through substantially orthogonal overlapping strips or bands of the conductive layers 1402 and 1403. Each intersection of overlapping strips in layers 1402 and 1403 corresponds to a phase-modulation pixel in the phase-control layer 1302. For example, as shown in FIG. 14, applying an appropriate current to a first strip 1406 of conductive layer 1402 running substantially parallel to the x-axis and simultaneously applying an appropriate current to a second strip 1408 of conductive layer 1403 running substantially parallel to the y-axis produces a current flowing through a region 1410 of layer 1401 between the overlapping strips 1406 and 1408. As a result, the refractive index of the region 1410 is changed. The degree to which the refractive index is changed can vary depending on the magnitude of the current flowing through the region 1410. Thus, a phase-modulation pixel in the phase-control layer 1302 includes a region of phase-modulation layer 1401 sandwiched between substantially orthogonal, overlapping strips of conductive layers 1402 and 1403, and the refractive index of the phase-modulation pixel is controlled by applying appropriate currents to the overlapping strips.

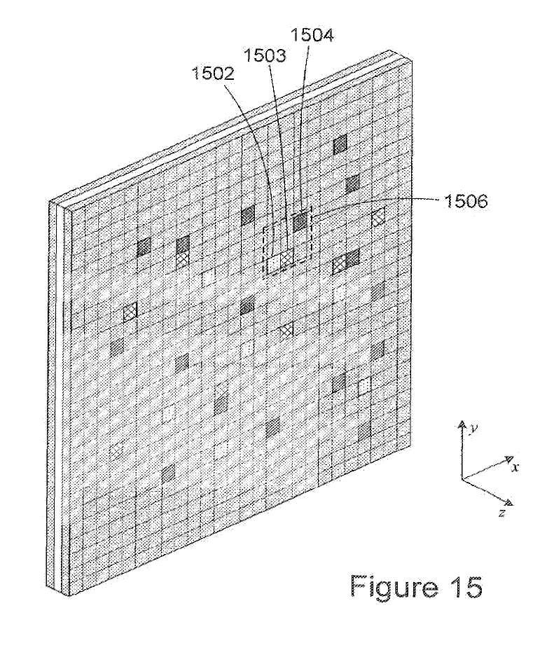

The refractive index of each pixel can be varied by applying a different current to each pixel. FIG. 15 shows a number of highlighted phase-modulation pixels having different refractive indices in accordance with embodiments of the present invention. Each pixel is electronically addressable as described above with reference to FIG. 14, and depending on the magnitude of the current flowing through each pixel, the effective refractive index of each pixel can be separately adjusted. For example, shaded pixels 1502-1504 each represent pixels having different effective refractive indices which result from flowing different currents through each of the pixels 1502-1504. The change in the effective refractive index can range from a few percent to approximately 70%, but coupled with a resonant negative pixel, the change in the refractive index is larger.

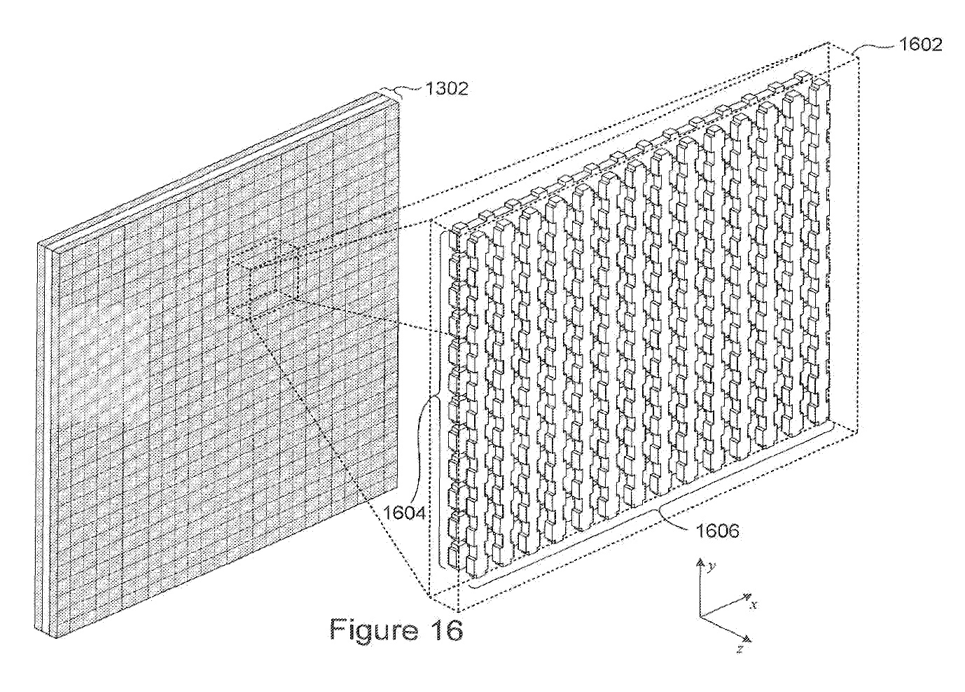

The phase-control layer 1302 can be composed of a NIM crossbar, and each electronically addressable phase-modulation pixel can be composed of one or more resonant elements. FIG. 16 shows an isometric view and an enlargement of a region 1602 of the phase-control layer 1302 shown in FIG. 13 configured in accordance with embodiments of the present invention. The enlarged region 1602 reveals that the phase-control layer 1302 is implemented as a NIM crossbar comprising a chalcogenide glass intermediate layer sandwiched between a first layer of substantially parallel nanowires 1604 and a second layer of approximately parallel nanowires 1606, where the nanowires in the first layer 1604 are approximately perpendicular to the nanowires in the second layer 1606. The NIM crossbar and resonant elements are configured and operated as described above with reference to the subsections Negative Index Material Crossbars and Resonant Elements.

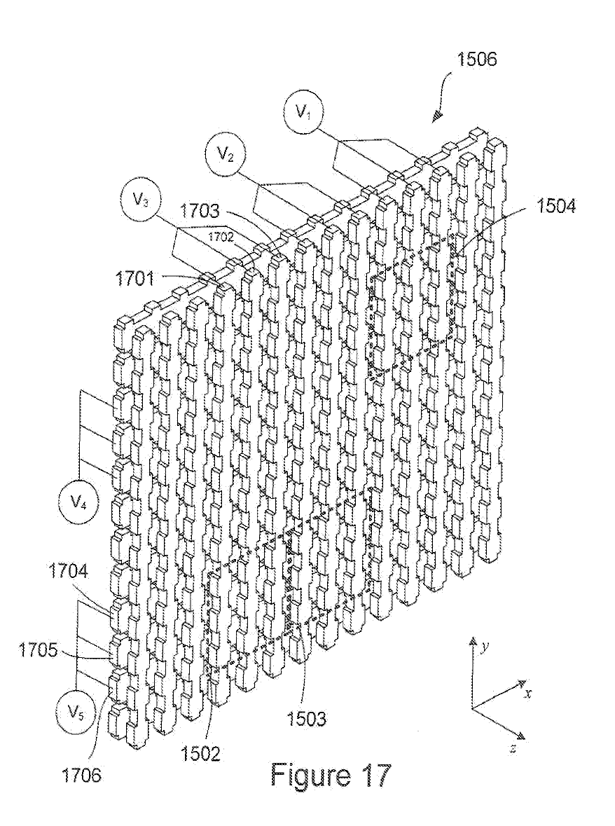

FIG. 17 shows an isometric view and enlargement of a region 1506 of the phase-control layer 1302 shown in FIG. 15 configured and operated using currents in accordance with embodiments of the present invention. The pixels 1502-1504 of FIG. 15 are enlarged and identified by dashed-line enclosures. The pixels 1502-1504 are each composed of a square array of 9 resonant elements. A change in the refractive index of a pixel is the result of changes in the refractive indices of the resonant elements comprising the pixel. As described above in the subsections Resonant Elements, a refractive index change of a resonant element can be the result of a phase change within the intermediate layer comprising a resonant element. As shown in FIG. 17, the individual nanowires of the pixels 1502-1504 are electronically coupled to current sources so that the resonant elements of each pixel can be individually and electronically addressed. In order to change the refractive index of the resonant elements comprising the pixel 1502, the nanowires of the pixel 1502 are electronically addressed by passing the same current through the nanowires 1701-1703 and a different current through all three of the nanowires 1704-1706 resulting the same current flowing through each of the nine resonant elements comprising the pixel 1502. As a result, the refractive indices of the individual resonant elements comprising the pixel 1502 are changed to the same refractive index, and light transmitted through the pixel 1502 acquires a transmission phase associated with the refractive index of the resonant elements comprising the pixel 1502. For example, the refractive index of the nine resonant elements comprising the pixel 1502 can be shifted as described above with reference to FIG. 11. The pixels 1503 and 1504 are also separately and electronically addressed by applying different sets of currents to the nanowires comprising the pixels 1503 and 1504 to produce different refractive indices associated with each pixel.

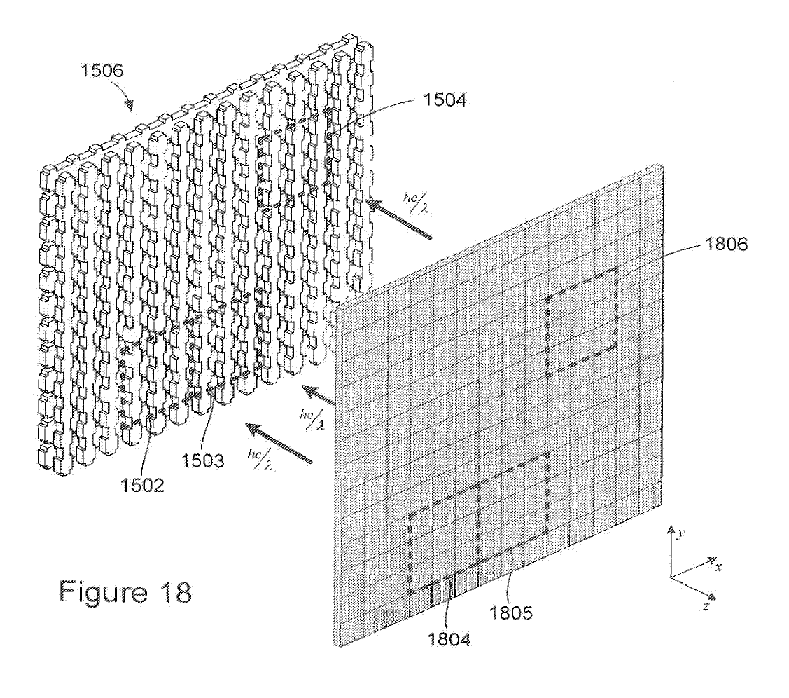

FIG. 18 shows an isometric view and enlargement of the region 1506 of the phase-control layer 1302 shown in FIG. 15 configured and operated using ER in accordance with embodiments of the present invention. As described above in the subsection Resonant Elements, the refractive index of a resonant element can be changed by illuminating each resonant element with ER of an appropriate wavelength and duration. As shown in FIG. 18, a laser array 1802 comprising individual lasers is operated to selectively illuminate the resonant elements of each pixel. For example, a sub-array of lasers 1804 illuminates the resonant elements of the pixel 1502 changing the phase of the intermediate layers of the resonant elements comprising the pixel 1502, as described above with reference to FIG. 12. The refractive indices of the individual resonant elements comprising the pixel 1502 are changed to the same refractive index, and light transmitted through the pixel 1502 acquires a transmission phase associated with the refractive index of the resonant elements comprising the pixel 1502. The refractive index of the nine resonant elements comprising the pixel 1502 are also changed as described above with reference to FIG. 12 be separately illuminating the pixels 1503 and 1504 with the sub-arrays of lasers 1805 and 1806, respectively.

Embodiments of the present invention are not limited to pixels comprising a square array of nine resonant elements. Because currents pass through individual crossed nanowires, the number of square array resonant elements comprising a single pixel can range from as few as 4 to hundreds even thousands of resonant elements. In addition, the individual nanowires enable pixels to have various shapes such as square, rectangular, circular, elliptical, triangular, or any other suitable shape.

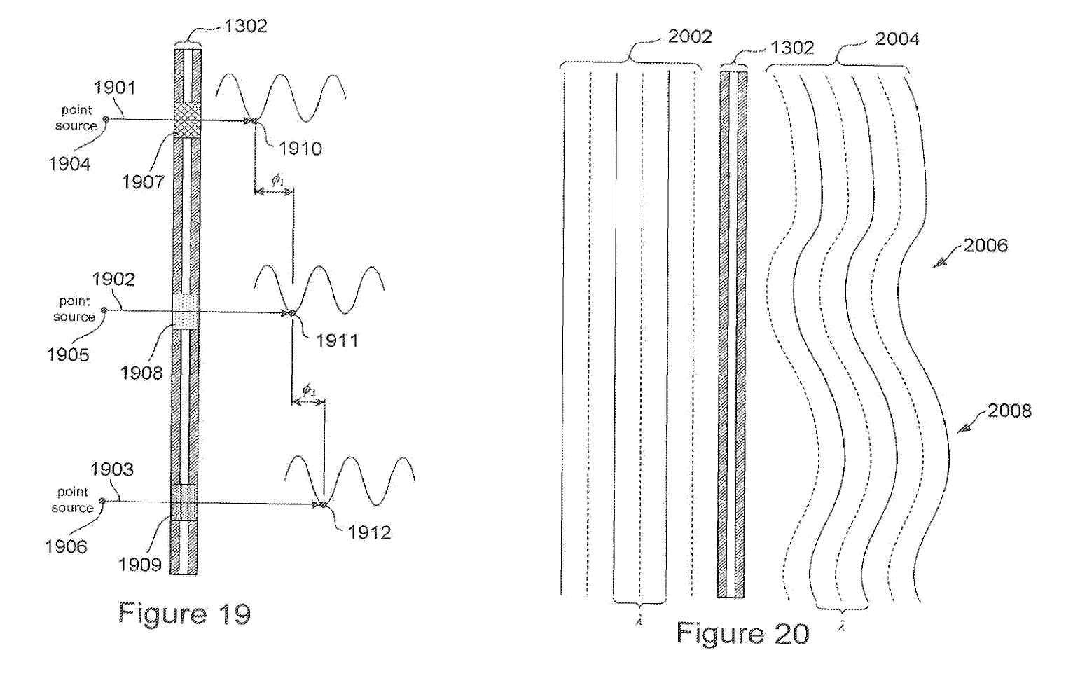

FIG. 19 shows a side view of rays of light transmitted through three pixels of the phase-control layer 1302 operated in accordance with embodiments of the present invention. Rays of light 1901-1903 emanating from point sources 1904-1906 pass through pixels 1907-1909, respectively. In the example shown in FIG. 19, each pixel is electronically addressed or illuminated, as described above with reference to FIGS. 17-18, and has a different refractive index with pixel 1907 having the largest refractive index, pixel 1908 having the second largest refractive index, and pixel 1909 having the smallest refractive index. As rays 1901-1903 enter associated pixels 1907-1909, the light slows to a velocity v=c/n, where v is the velocity of light propagating through a pixel, c is the speed of light in free space, and n is the refractive index of the pixel. Thus, the ray 1903 passing through the pixel 1907 has the slowest velocity, the ray 1905 passing through the pixel 1908 has the second slowest velocity, and the ray 1906 has the highest relative velocity. Points 1910-1912 represent points on electromagnetic waves that simultaneously enter the pixels 1907-1909, respectively, but due to the different refractive indices at each pixel, the points 1910-1912 of the electromagnetic waves emerge at different times from the pixels 1907-1909 and, therefore, are located at different distances from the phase-control layer 1302. In other words, the electromagnetic waves emerging from the pixels 1907-1909 acquire transmission phase shifts. As shown in FIG. 19, the relative phase difference between the electromagnetic waves emerging from pixels 1907 and 1908 is φ₁, and the relative phase difference between electromagnetic waves emerging from pixels 1908 and 1909 is φ₂, with the greatest relative phase difference of φ₁+φ₂ for electromagnetic waves emerging from pixels 1907 and 1909. The current or ER applied to the pixels 1907-1909 can be rapidly modulated, which, in turn, rapidly modulates the refractive indices of the pixels 1907-1909 resulting in rapid changes in relative phase differences between rays emerging from the pixels 1907-1909.

FIG. 20 shows a side view of quasimonochromatic light entering and emerging from the phase-control layer 1302 in accordance with embodiments of the present invention. Ideally monochromatic light is used. However, in practice it is recognized that a light source does not emit monochromatic light but instead can emit light in a narrow band of wavelengths, which is called “quasimonochomatic light.” Quasimonochromatic light enters the phase-control layer 1302 with uniform wavefronts 2002 of wavelength λ. Each wavefront crest is identified by a solid line and each wavefront trough is identified by a dashed line. As shown in FIG. 20, each wavefront enters the phase-control layer 1302 with substantially the same phase. The pixels (not identified) of the phase-control layer 1302 are selectively addressed to produce non-uniform wavefronts 2004 by affecting the transmission phase of different portions of the non-uniform wavefront 2004 by affecting the phase of different portions of the non-uniform wavefront 1904. The non-uniform wavefronts 2004 can result from certain portions of the incident uniform wavefronts 2002 passing through pixels that have been electronically configured with relatively different refractive indices. For example, portions of non-uniform wavefronts in region 2006 emerge from the phase-control layer 1302 later than portions of non-uniform wavefronts in region 2008. In other words, the phase-control layer 1302 is configured to introduce relatively large transmission phase differences between portions of wavefronts emerging in region 2006 and portions of wavefronts emerging in region 2008. The non-uniform wavefront 2004 contains substantially all the information needed to reproduce a wavefront reflected from an object when viewed over a particular range of viewing angles.

Light emerging from phase-modulation pixels of the phase-control layer 1302 pass through corresponding intensity-control pixels of intensity-control layer 1304, as described above with reference to FIG. 13. Each intensity-control pixel can be filled with a liquid crystal. In certain embodiments, the intensity-control layer 1304 can be a liquid crystal layer. Each intensity-control pixel of intensity-control layer 1304 typically consists of a layer of liquid crystal molecules aligned between two transparent electrodes, and two polarizing filters with substantially perpendicular axes of transmission. The electrodes are composed of a transparent conductor such as Indium Tin Oxide (“ITO”). Thus, with no liquid crystal filling the pixel between the polarizing filters, light passing through the first filter is blocked by the second filter. The surfaces of the transparent electrodes contacting the liquid crystal material are treated with a thin polymer molecule that aligns the liquid crystal molecules in a particular direction.

Before applying an electric field to a pixel, the orientation of the liquid crystal molecules is determined by the alignment of the polymer deposited on surfaces of the transparent electrode. An intensity-control pixel comprising twisted nematic liquid crystals, the surface alignment direction of the polymer on the first electrode is substantially perpendicular to the alignment direction of the polymer on the second electrode, and the liquid crystal molecules between the electrodes arrange themselves in a helical structure. Because the liquid crystal is birefringent, light passing through one polarizing filter is rotated by the liquid crystal helix allowing the light to pass through the second polarized filter.

When a voltage is applied across the electrodes of an intensity-control pixel, a torque is created that aligns the liquid crystal molecules parallel to the electric field, distorting the helical structure. This reduces the rotation of the polarization of the incident light, and the pixel appears grey. When the applied voltage is large enough, the liquid crystal molecules are almost completely untwisted and aligned with the electric field, and the polarization of the incident light is not rotated as it passes through the liquid crystals. This light will then be mainly polarized perpendicular to the second filter, and as a result, the light is blocked by the second filter and the pixel appears black. By controlling the voltage applied to each intensity-control pixel, the intensity of light passing through each intensity-control pixel can be varied thus constituting different levels of grey.

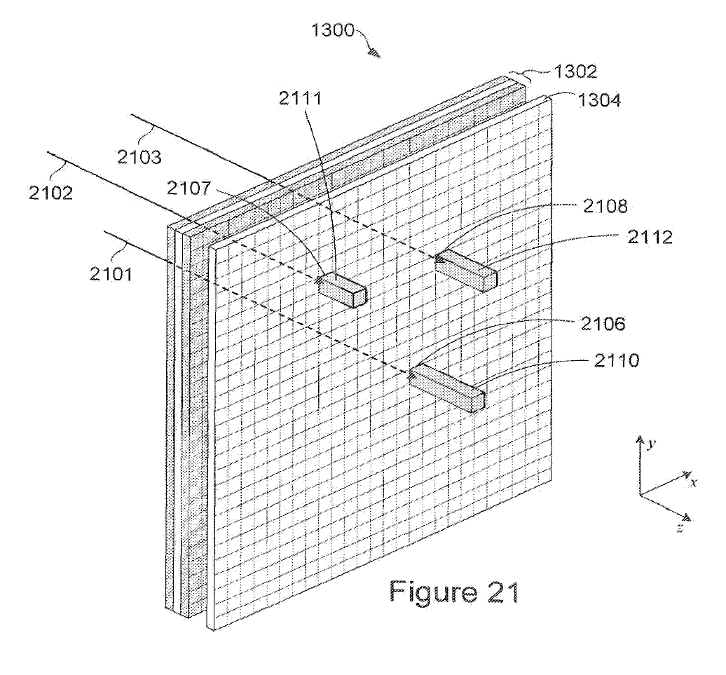

FIG. 21 shows intensity levels associated with rays 2101-2103 passing through pixels of phase-control layer 1302 and intensity-control layer 1304 in accordance with embodiments of the present invention. The rays emerging from phase-modulation pixels in phase-control layer 1302 pass through intensity-control pixels 2106-2108 that are each configured to produce a different intensity level. As shown in FIG. 21, bars 2110-2112 represent intensity levels of light emerging from intensity-control pixels 2106-2108. The length of bar 2111 is shorter than the length of bar 2110 representing the relatively lower intensity level of light emerging from pixel 2107 than from pixel 2106. The intensity level of light emerging from an intensity-control pixel is selectively determined by the magnitude of the voltage applied to the pixel. For example, a relatively higher voltage applied to pixel 2107 than to pixel 2106 results in a relatively lower intensity level for light emerging from pixel 2107 than for light emerging from pixel 2106.

In other embodiments, color filters can be placed over each intensity-control pixel so that colored light emerges from each intensity-control pixel. For example, three adjacent intensity-control pixels can be combined to form an RGB color pixel. Red, green, and blue primary color filters can be placed over each of three adjacent intensity-control pixels. A red filter can be placed over a first pixel, a blue filter can be placed over a second pixel, and a green filter can be placed over a third pixel. Light of varying colors can be generated by varying the intensity of light passing through each of the three pixels of the RGB pixel. In other embodiments, colors other than red, green, and blue can be used for the three intensity-control pixels comprising the color pixel. For example, cyan, magenta, and yellow filters can be placed over each of three adjacent intensity-control pixels. Note that since the intensity-control pixels are configured with sub-wavelength dimensions, in other embodiments groups of pixels can be configured such that each of the group of pixels respond to different quasimonochromatic light such as red, green and blue light. The group of pixels can have sub-wavelength dimensions and dynamically generate a color hologram.

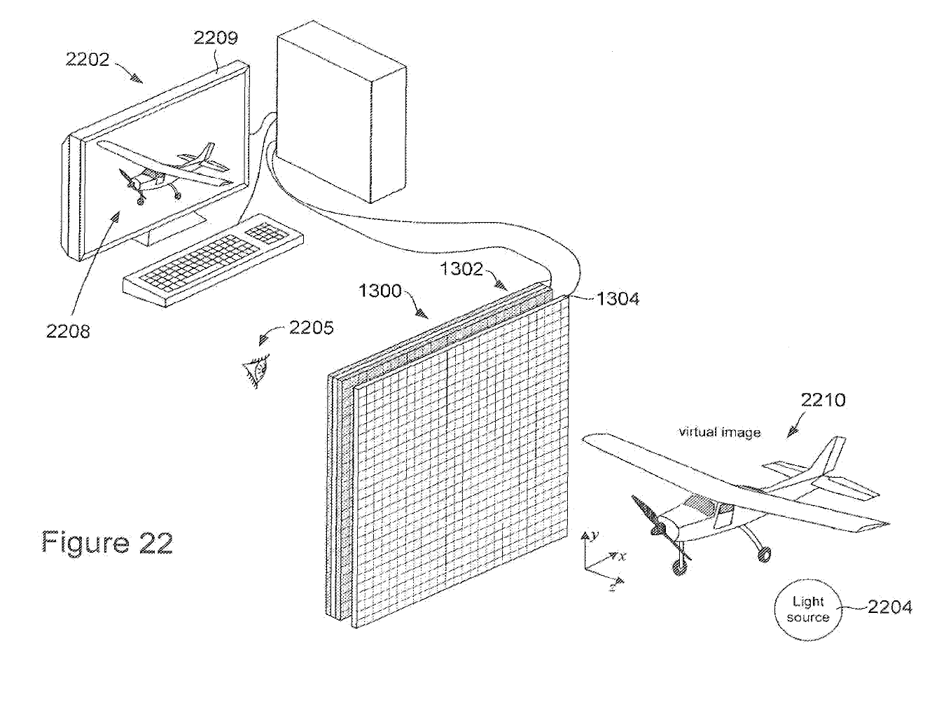

FIG. 22 shows a system for generating three-dimensional images in accordance with embodiments of the present invention. The system comprises a computer system 2202, an electronically addressable dynamic hologram 1300, and a light source 2204. The computer system 2202 includes a processor and memory that processes and stores the data representing various images of objects and scenes. The images are stored in the memory as data files comprising three dimensional coordinates and associated intensity and color values. The image observed by the viewer is called a “virtual image.” A three dimensional virtual image of an object can be displayed on one side of the hologram 1300 as follows. The light source 2204 is positioned and configured to emit substantially quasimonochromatic light that passes through the layers 1302 and 1304 of the hologram 1300 to an observer 2205 located on the opposite side of the hologram 1300. A program stored on the computer system 2202 memory displays the image as a three-dimension virtual image that appears suspended behind the hologram 1300 by translating the data files into electronic addresses that are applied to particular phase-modulation pixels in phase-control layer 1302 and intensity-control pixels in intensity-control layer 1304. Light passing through each phase-modulation pixel acquires an appropriate transmission phase and passing through each intensity-control pixel acquires an intensity level adjustment in order to reproduce the wavefront reflected by the object over a range of viewing angles. As a result, the image stored in the computer appears as a three-dimensional image suspended behind the hologram 1300 opposite the light source 2204. For example, as shown in FIG. 22, the computer system 2202 displays a two-dimensional image of an airplane 2208 on a monitor 2209 and displays a three-dimensional virtual image 2210 of the same airplane on the side of the hologram 1300 opposite the viewer 2205. A viewer 2205 looking at the hologram 1300 sees the airplane 2210 in depth by varying the position of her head or changing her perspective of the view.

In other embodiments, a laser array can be electronically coupled to the computer system 2202. Rather than electronically addressing the phase-modulation pixels of the phase-modulation layer 1302 as described above with reference to FIG. 22, a program stored in the computer system 2202 memory displays the image by translating data files into signals that activate laser drivers of the individual lasers in the laser array selectively changing the refractive index of resonant elements.

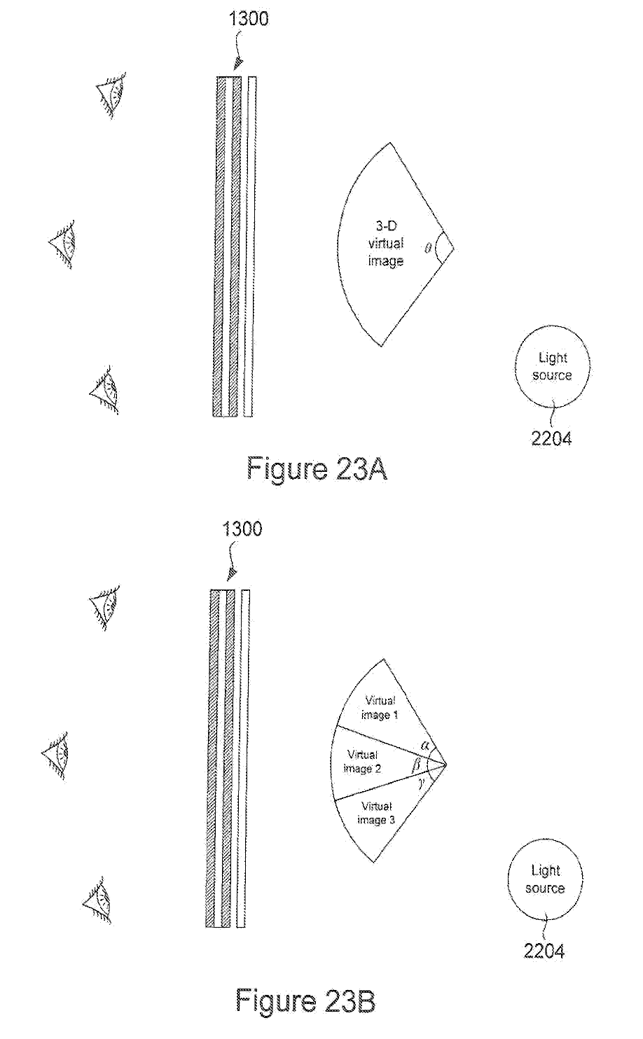

FIG. 23A shows a schematic representation of a viewing angle over which a viewer can view a three-dimensional virtual image with the hologram 1300 in accordance with embodiments of the present invention. A viewer looks through the hologram 1300 and sees a three-dimensional virtual image in depth, and by varying the viewer's viewing position within the viewing angle θ, the viewer can change the perspective of the view. Because each phase-modulation pixel and intensity-control pixel is electronically addressable and the refractive index of each pixel can be rapidly changed, moving virtual images, such as motion pictures, of three-dimensional objects and scenes can be displayed.

Operation of the hologram 1300 is not limited to producing a single three-dimensional image. In other embodiments, the hologram 1300 can be used to simultaneously produce one or more images, where each image can be viewed over a different range of viewing angles. FIG. 23B shows a schematic representation of the hologram 1300 displaying three different three-dimensional virtual images in accordance with embodiments of the present invention. The pixels of the hologram 1300 are individually and electronically addressed to produce interfering wavefronts producing three separate and distinct three-dimensional virtual images that can each be viewed over different viewing angles. For example, as shown in FIG. 23B, the three-dimensional virtual images 1-3 can each be viewed over different viewing angles α, β, and γ, respectively. An viewer can view the three-dimensional virtual image 1 over the range of viewing angles α. As the viewer changes position to view the three-dimensional virtual image 1 over the range of viewing angles β, the three-dimensional virtual image 1 appears to morph into the three-dimensional virtual image 2.

Although the present invention has been described in terms of particular embodiments, it is not intended that the invention be limited to these embodiments. Modifications will be apparent to those skilled in the art. For example, embodiments of the present invention are not limited to the light source 2204 being positioned on the side of the hologram 1300 opposite the image. In other embodiments, the hologram 1300 can be operated in a reflective mode where the light source 2204 can be positioned and configured to emit substantially quasimonochromatic light reflected off of pixels of the layers 1302 of the hologram 1300 creating an image on the same side as the light source 2204. In other embodiments, more than one phase-control layer can be included to control the phase and more than one intensity-control layer can be included to control the intensity. Thus, the last image viewed can be displayed by simply turning on the light source 2204 and the intensity-control layer 1304 without having to electronically configure the phase-modulation pixels of the phase-control layer 1302. Embodiments of the present invention are not limited to light first passing through the phase-control layer 1302 followed by light passing through the intensity-control layer 1304. In other embodiments, a hologram can be configured and operated in accordance with embodiments of the present invention where light first passes through the intensity-control layer 1304 and then passes through the phase-control layer 1302.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An electronically programmable material crossbar (500) comprising:
a first layer of approximately parallel nanowires (502), each nanowire having substantially regularly spaced fingers (612);
a second layer of approximately parallel nanowires (504) that overlay the nanowires in the first layer, each nanowire having substantially regularly spaced fingers (608), wherein the nanowires in the first layer are approximately perpendicular in orientation to the nanowires in the second layer; and
resonant elements (812) include a chalcogenide-based layer (1000) sandwiched between the nanowire in the first layer and the nanowire in the second layer.

2. The crossbar of claim 1 wherein the chalcogenice-based layer further comprises a chalcogenide glass.

3. The crossbar of claim 1 wherein the refractive index of each resonant element is controlled by a change in the phase of the chalcogenide-based layer

4. The crossbar of claim 3 wherein the change in the phase of the intermediate layer further comprises a change in the chalcogenice-based layer from an amorphous phase to a crystalline phase.

5. The crossbar of claim 4 wherein the change in the chalcogenice-based layer from an amorphous phase to a crystalline phase further comprises application of a current of an appropriate magnitude and duration.

6. The crossbar of claim 4 wherein the change in the chalcogenice-based layer from an amorphous phase to a crystalline phase further comprises application of electromagnetic radiation of an appropriate wavelength and duration.

7. The crossbar of claim 3 wherein the change in the phase of the chalcogenice-based layer further comprises the change in the chalcogenice-based layer from a crystalline phase to an amorphous phase.

8. The crossbar of claim 7 wherein the change in the chalcogenice-based layer from an amorphous phase to a crystalline phase further comprises application of a current of an appropriate magnitude and duration.

9. The crossbar of claim 7 wherein the change in the chalcogenice-based layer from an amorphous phase to a crystalline phase further comprises application of electromagnetic radiation of an appropriate wavelength and duration.

10. The crossbar of claim 1 wherein the nanowires in the first and second layers further comprise:
the finger of adjacent nanowires within the same layer are substantially aligned;
notches between fingers of nanowires in the first layer are substantially aligned with notches between fingers of the nanowires in the second layer; and
the cross-sectional dimensions of the nanowires in the first layer are relatively larger than the cross-sectional dimensions of the nanowires in the second layer.

11. A dynamically reconfigurable hologram (1300) comprising:
a phase-control layer (1302) including an electronically programmable material crossbar configured in accordance with claim 1 to form a two-dimensional array of phase-modulation pixels (1312); and
an intensity-control layer (1304) including a two-dimensional array of intensity-control pixels (1314), wherein one or more three-dimensional motion pictures can be produced by electronically addressing the individual phase-modulation pixels and intensity-control pixels in order to phase shift and control the intensity of light emanating from the pixels of the hologram.

12. The hologram of claim 11 wherein electronically addressing the phase-modulation pixels further comprises selective application of a current to each phase-modulation pixel, each current changing the refractive index of a phase-modulation pixel.

13. The hologram of claim 12 wherein changing the refractive index of a phase-modulation pixel further comprises changing the phase of an intermediate layer within each resonant element comprising the phase-modulation pixel.

14. The hologram of claim 11 wherein the three-dimensional image can be produced by transmitting light through the hologram-producing system (1300) from a light source located opposite the three-dimensional image or reflecting light from the hologram from a light source located on the same side of the hologram as the one or more images produced by the hologram, wherein the light source further comprises a quasimonochromatic light source.

15. A system for generating a three-dimensional image comprising:
a computer system (2202) including a processor and memory;
a dynamically reconfigurable hologram (1300) configured in accordance with claim 11 and coupled to the computer system; and
a light source (2204) positioned and configured to emit quasimonochromatic light into the hologram, wherein data representing one of more images is stored in the memory and the processor executes a computer program that displays the image data as one or more three-dimensional images by electronically addressing the phase-modulation pixels and the intensity-control pixels to phase shift and control the intensity of light emanating from the hologram.
